(19) United States
(12) Patent Application Publication
(10) Pub. No.: US 2015/0189642 A1
(43) Pub. Date: Jul. 2, 2015

(54) METHOD FOR TRANSRECEIVING CONTROL SIGNAL AND APPARATUS FOR SAME

(71) Applicant: LG ELECTRONICS INC., Seoul (KR)

(72) Inventors: Suckchel Yang, Anyang-si (KR); Joonkui Ahn, Anyang-si (KR)

(73) Assignee: LG ELECTRONICS INC., Seoul (KR)

(21) Appl. No.: 14/409,900

(22) PCT Filed: Jun. 24, 2013
(86) PCT No.: PCT/KR2013/005554

§ 371 Date: Dec. 19, 2014

Related U.S. Application Data
(60) Provisional application No. 61/662,923, filed on Jun. 22, 2012.

(51) Int. Cl. H04W 72/04; H04W 52/02; H04L 5/00

(52) U.S. Cl. CPC H04W 72/048; H04W 72/0413; H04L 5/0055; H04W 52/0212

(57) ABSTRACT

The present invention relates to a wireless communication system. More specifically, the present invention relates to a method for transreceiving a control signal from a first terminal in the wireless communication system which supports device-to-device (D2D) communication and an apparatus for same, the method comprising the steps of: receiving from a base station a signal which triggers the D2D communication between the first terminal and a second terminal; transmitting data to the second terminal; receiving from the second terminal an acknowledgement/non-acknowledgement (ACK/NACK) signal with respect to the data; and transmitting to the base station an ACK/NACK delivery signal for delivering the ACK/NACK signal to the base station.

### TECHNICAL FIELD

The present invention relates to a wireless communication system, and more particularly, to a method and apparatus for transmitting and receiving feedback information for device-to-device (D2D) communication in a wireless communication system supporting D2D communication.

### BACKGROUND ART

Wireless communication systems are widely developed to provide a various kinds of communication services such as audio or data service. In general, a wireless communication system is a multiple access system capable of supporting communications with multiple users by sharing available system resources (bandwidths, transmission power, etc.). Examples of the multiple access system include code division multiple access (CDMA) system, frequency division multiple access (FDMA) system, time division multiple access (TDMA) system, orthogonal frequency division multiple access (OFDMA) system, single carrier frequency division multiple access (SC-FDMA) system, multi-carrier frequency division multiple access (MC-FDMA) system, etc. In a wireless communication system, a user equipment (UE) can receive information from a base station (BS) in downlink (DL) and transmit information to the BS in uplink (UL). The information transmitted or received by the UE includes data and various control information and various physical channels are present according to the type and usage of the information transmitted or received by the UE.

### DISCLOSURE

### Technical Problem

An object of the present invention devised to solve the problem lies in a method and apparatus for efficiently transmitting and receiving a control signal in a wireless communication system for supporting device-to-device (D2D) communication.

Another object of the present invention devised to solve the problem lies in a method and apparatus for providing feedback information to a base station (BS) so as to efficiently control D2D communication by the BS in a wireless communication system.

Another object of the present invention devised to solve the problem lies in a method and apparatus for providing feedback information to D2D communication to a BS even if one user equipment (UE) that performs D2D communication is outside coverage of the BS in a wireless communication system.

It is to be understood that both the foregoing general description and the following detailed description of the present invention are exemplary and explanatory and are intended to provide further explanation of the invention as claimed.

### Technical Solution

In an aspect of the present invention, provided herein is a method for transmitting and receiving a control signal by a first user equipment (UE) in a wireless communication system supporting a device-to-device (D2D) communication, the method comprising receiving a signal for triggering a D2D communication between the first UE and a second UE from a base station (BS); transmitting data to the second UE; receiving an acknowledgement (ACK)/negative ACK (NACK) signal for the data from the second UE; and transmitting, to the BS, an ACK/NACK delivery signal for transmitting the ACK/NACK signal to the BS.

Preferably, the ACK/NACK delivery signal may indicate ACK when the ACK/NACK signal indicates ACK, and the ACK/NACK delivery signal may indicate NACK when the ACK/NACK signal indicates NACK or discontinuous transmission (DTX).

Preferably, the ACK/NACK delivery signal may indicate ACK when the ACK/NACK signal indicates ACK, the ACK/NACK delivery signal may indicate NACK when the ACK/NACK signal indicates NACK, and the ACK/NACK delivery signal may indicate DTX when the ACK/NACK signal indicates DTX.

Preferably, the ACK/NACK delivery signal may be transmitted via physical uplink control channel (PUCCH) format 1a/1b.

Preferably, the method further comprises transmitting, to the second UE, scheduling information for scheduling data transmission to the second UE, wherein the scheduling information may comprise resource allocation information, information about a modulation and coding scheme, and/or information about a transport block size, for data transmission to the second UE.

Preferably, the method further comprises receiving control information for the D2D communication between the first UE and the second UE from the BS, wherein the control information for the D2D communication may comprise information about a specific subframe in which data transmission to the second UE is permitted, and the data transmission to the second UE is performed in the specific subframe.

Preferably, information about resource and time for transmitting the ACK/NACK delivery signal to the BS may be received via higher layer signaling or received via the signal for triggering the D2D communication.

Preferably, the second UE may be outside a coverage of the BS.

In another aspect of the present invention, provided herein is a first user equipment (UE) for transmitting and receiving a control signal in a wireless communication system for supporting a device-to-device (D2D) communication, the first UE comprising: a radio frequency (RF) unit; and a processor, wherein the processor is configured to receive a signal for triggering a D2D communication between the first UE and a second UE from a base station (BS) through the RF unit, to transmit data to the second UE, to receive an acknowledgement (ACK)/negative ACK (NACK) signal for the data from the second UE, and to transmit, to the BS, an ACK/NACK delivery signal for transmitting the ACK/NACK signal to the BS.

Preferably, the ACK/NACK delivery signal may indicate ACK when the ACK/NACK signal indicates ACK, and the ACK/NACK delivery signal may indicate NACK when the ACK/NACK signal indicates NACK or discontinuous transmission (DTX).

Preferably, the ACK/NACK delivery signal may indicate ACK when the ACK/NACK signal indicates ACK, the ACK/NACK delivery signal may indicate NACK when the ACK/NACK signal indicates NACK, and the ACK/NACK delivery signal may indicate DTX when the ACK/NACK signal indicates DTX.

Preferably, the ACK/NACK delivery signal may be transmitted via physical uplink control channel (PUCCH) format 1a/1b.

Preferably, the processor is further configured to transmit, to the second UE, scheduling information for scheduling data transmission to the second UE from the first UE, and the scheduling information may comprise resource allocation information, information about a modulation and coding scheme, and/or information about a size of a transport block, for data transmission to the second UE from the first UE.

Preferably, the processor is further configured to receive control information for the D2D communication between the first UE and the second UE from the BS, and the control information for the D2D communication may comprise information about a specific subframe in which data transmission to the second UE from the first UE is permitted, and the data transmission to the second UE from the first UE is performed in the specific subframe.

Preferably, information about resource and time for transmitting the ACK/NACK delivery signal to the BS may be received via higher layer signaling or received via the signal for triggering the D2D communication.

Preferably, the second UE may be outside a coverage of the BS.

### Advantageous Effects

According to the present invention, a control signal may be efficiently transmitted and received in a wireless communication system for supporting device-to-device (D2D) communication.

According to the present invention, feedback information may be provided to a base station (BS) so as to efficiently control D2D communication by the BS in a wireless communication system.

In addition, according to the present invention, feedback information to D2D communication may be provided to a BS even if one user equipment (UE) that performs D2D communication is outside coverage of the BS in a wireless communication system.

It will be appreciated by persons skilled in the art that that the effects that could be achieved with the present invention are not limited to what has been particularly described hereinabove and other advantages of the present invention will be more clearly understood from the following detailed description taken in conjunction with the accompanying drawings.

### BRIEF DESCRIPTION OF DRAWINGS

The accompanying drawings, which are included to provide a further understanding of the invention, illustrate embodiments of the invention and together with the description serve to explain the principle of the invention.

FIG. 1 illustrates physical channels and a general method for transmitting signals on the physical channels in the LTE(-A) system.

FIG. 2 illustrates a structure of a radio frame used in an LTE(-A) system.

FIG. 3 illustrates a resource grid of one DL slot used in an LTE(-A) system.

FIG. 4 illustrates a downlink subframe structure used in the LTE(-A) system.

FIG. 5 illustrates a control channel allocated to a downlink subframe.

FIG. 6 illustrates a structure of a UL subframe in the LTE(-A) system.

FIG. 7 illustrates an example of PHICH/UL grant (UG)-PUSCH timing.

FIG. 8 illustrates an example of PUSCH-PHICH/UL grant timing.

FIG. 9 illustrates an example in which a DL physical channel is allocated in a subframe.

FIG. 10 illustrates an example of a D2D data scheduling/transmitting procedure.

FIG. 11 illustrates an example of a D2D data scheduling/transmitting procedure.

FIG. 12 illustrates an example of a D2D feedback procedure according to the present invention.

FIG. 13 illustrates an example of a D2D feedback procedure according to the present invention.

FIG. 14 is a diagram illustrating a BS 110 and a UE 120 to which the present invention is applicable.

### DETAILED DESCRIPTION OF THE INVENTION

The following embodiments of the present invention can be applied to a variety of wireless access technologies, for example, code division multiple access (CDMA), frequency division multiple access (FDMA), time division multiple access (TDMA), orthogonal frequency division multiple access (OFDMA), single carrier frequency division multiple access (SC-FDMA), and the like. CDMA may be embodied through wireless (or radio) technology such as universal terrestrial radio access (UTRA) or CDMA2000. TDMA may be embodied through wireless (or radio) technology such as global system for mobile communication (GSM)/general packet radio service (GPRS)/enhanced data rates for GSM evolution (EDGE). OFDMA may be embodied through wireless (or radio) technology such as institute of electrical and electronics engineers (IEEE) 802.11 (Wi-Fi), IEEE 802.16 (WiMAX), IEEE 802-20, and evolved UTRA (E-UTRA). UTRA is a part of universal mobile telecommunications system (UMTS). 3^{rd} generation partnership project (3GPP) long term evolution (LTE) is a part of E-UMTS (Evolved UMTS), which uses E-UTRA. LTE-Advanced (LTE-A) is an evolved version of 3GPP LTE. Throughout this specification, the LTE system may be referred to as a system according to 3^{rd} generation partnership project (3GPP) technical specification (TS) 36 8 (Release 8). In addition, in this specification, the LTE-A system may be referred to as a system according to 3GPP TS 36 series Release 9 and 10. The LTE(-A) system may be called to include the LTE system and the LTE-A system. For clarity, the following description focuses on 3GPP LTE(-A) system. However, technical features of the present invention are not limited thereto.

In a mobile communication system, a UE may receive information from a BS in downlink and transmit information in uplink. The information transmitted or received by the UE may be data and various control information. In addition, there are various physical channels according to the type or use of the information transmitted or received by the UE.

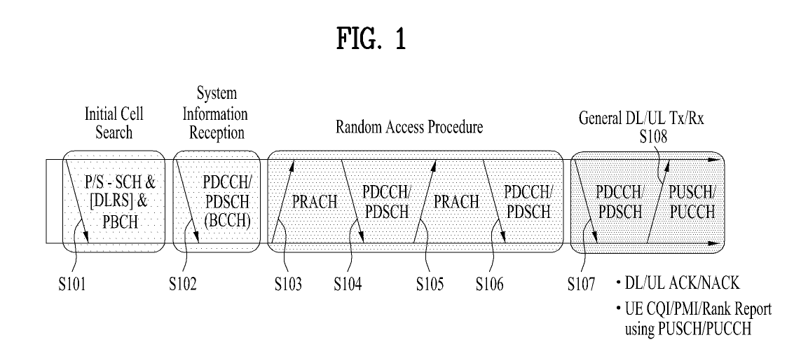

FIG. 1 illustrates physical channels and a general method for transmitting signals on the physical channels in the LTE(-A) system.

When a UE is powered on or enters a new cell, the UE performs initial cell search in step S101. The initial cell search involves acquisition of synchronization to an eNB. To this end, the UE synchronizes its timing to the eNB and acquires information such as a cell identifier (ID) by receiving a primary synchronization channel (P-SCH) and a secondary synchronization channel (S-SCH) from the eNB. Then the UE may acquire broadcast information in the cell by receiving a physical broadcast channel (PBCH) from the eNB. During the initial cell search, the UE may monitor a DL channel state by receiving a downlink reference signal (DL RS).

After the initial cell search, the UE may acquire more detailed system information by receiving a physical downlink control channel (PDCCH) and receiving a physical downlink shared channel (PDSCH) based on information of the PDCCH in step S102.

To complete access to the eNB, the UE may perform a random access procedure such as steps S103 to S106 with the eNB. To this end, the UE may transmit a preamble on a physical random access channel (PRACH) (S103) and may receive a response message to the preamble on a PDCCH and a PDSCH associated with the PDCCH (S104). In the case of a contention-based random access, the UE may additionally perform a contention resolution procedure including transmission of an additional PRACH (S105) and reception of a PDCCH signal and a PDSCH signal corresponding to the PDCCH signal (S106).

After the above procedure, the UE may receive a PDCCH and/or a PDSCH from the eNB (S107) and transmit a physical uplink shared channel (PUSCH) and/or a physical uplink control channel (PUCCH) to the eNB (S108), in a general UL/DL signal transmission procedure. Information that the UE transmits to the eNB is called Uplink Control Information (UCI). The UCI includes hybrid automatic repeat and request acknowledgement/negative acknowledgement (HARQ-ACK/NACK), scheduling request (SR), channel state information (CSI), etc. The CSI includes channel quality indicator (CQI), precoding matrix indicator (PMI), rank indication (RI), etc. UCI is generally transmitted on a PUCCH periodically. However, if control information and traffic data should be transmitted simultaneously, they may be transmitted on a PUSCH. In addition, the UCI may be transmitted aperiodically on the PUSCH, upon receipt of a request/command from a network.

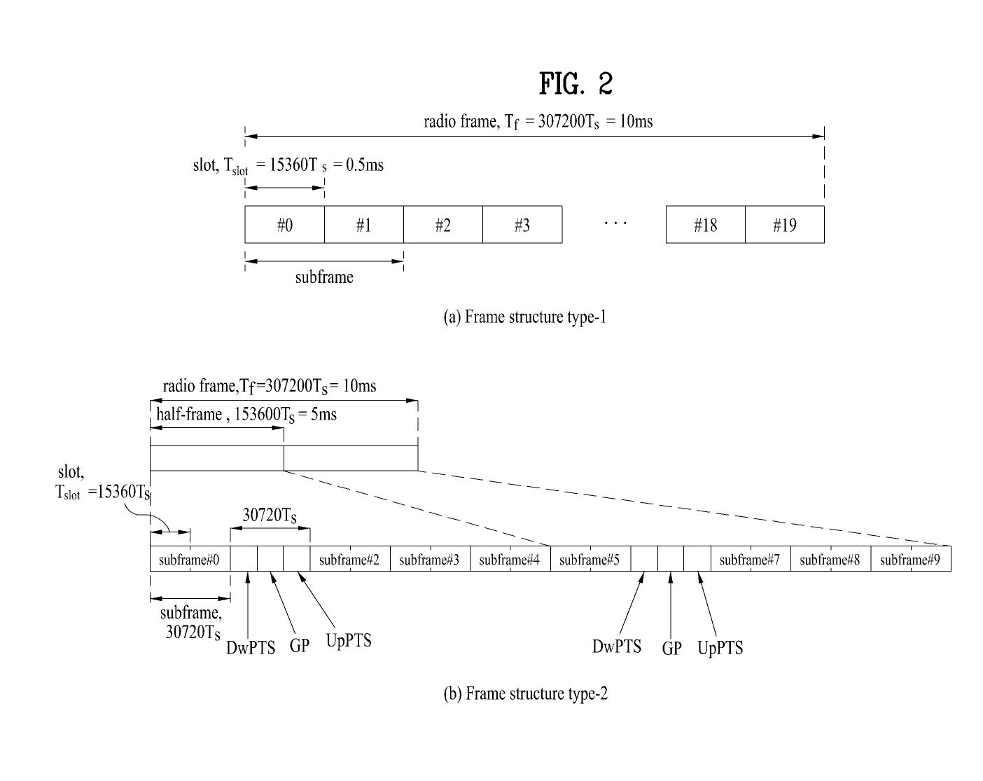

FIG. 2 illustrates a structure of a radio frame used in an LTE(-A) system. In a cellular OFDM radio packet communication system, uplink/downlink data packet transmission is performed in subframe units and one subframe is defined as a predetermined duration including a plurality of OFDM symbols. The LTE(-A) standard supports a type-1 radio frame structure applicable to frequency division duplex (FDD) and a type-2 radio frame structure applicable to time division duplex (TDD).

FIG. 2(a) shows the structure of the type-1 radio frame. A downlink radio frame includes 10 subframes and one subframe includes two slots in a time domain. A time required to transmit one subframe is referred to as a transmission time interval (TTI). For example, one subframe has a length of 1 ms and one slot has a length of 0.5 ms. One slot includes a plurality of OFDM symbols in a time domain and includes a plurality of resource blocks (RBs) in a frequency domain. In the LTE(-A) system, since OFDMA is used in downlink, an OFDM symbol indicates one symbol period. The OFDM symbol may be referred to as an SC-FDMA symbol or symbol period. A RB as a resource assignment unit may include a plurality of consecutive subcarriers in one slot.

The number of OFDM symbols included in one slot may be changed according to the configuration of a cyclic prefix (CP). The CP includes an extended CP and a normal CP. For example, if OFDM symbols are configured by the normal CP, the number of OFDM symbols included in one slot may be 7. If OFDM symbols are configured by the extended CP, since the length of one OFDM symbol is increased, the number of OFDM symbols included in one slot is less than the number of OFDM symbols in case of the normal CP. In case of the extended CP, for example, the number of OFDM symbols included in one slot may be 6. In the case where a channel state is unstable, such as the case where a UE moves at a high speed, the extended CP may be used in order to further reduce inter-symbol interference.

In case of using the normal CP, since one slot includes seven OFDM symbols, one subframe includes 14 OFDM symbols. At this time, a maximum of first two or three OFDM symbols of each subframe may be assigned to a physical downlink control channel (PDCCH) and the remaining OFDM symbols may be assigned to a physical downlink shared channel (PDSCH).

FIG. 2(b) shows the structure of the type-2 radio frame. The type-2 radio frame includes two half frames and each half frame includes five subframes, a downlink pilot time slot (DwPTS), a guard period (GP) and an uplink pilot time slot (UpPTS). One subframe includes two slots. For example, a downlink slot (e.g., DwPTS) is used for initial cell search, synchronization or channel estimation of a UE. For example, an uplink slot (e.g., UpPTS) is used for channel estimation of a BS and uplink transmission synchronization of a UE. For example, the uplink slot (e.g., UpPTS) may be used to transmit a sounding reference signal (SRS) for channel estimation in an eNB and to transmit a physical random access channel (PRACH) that carriers a random access preamble for uplink transmission synchronization. The GP is used to eliminate interference generated in uplink due to multi-path delay of a downlink signal between uplink and downlink. Table 1 below shows an uplink (UL)-downlink (DL) configuration in subframes in a radio frame in a TDD mode.

TABLE 1

| | Downlink- | | | | | | | | | | |
|---|---|---|---|---|---|---|---|---|---|---|---|
| | to-Uplink | | | | | | | | | | |
| Uplink- | Switch- | | | | | | | | | | |
| downlink | point | Subframe number | | | | | | | | | |
| configuration | periodicity | 0 | 1 | 2 | 3 | 4 | 5 | 6 | 7 | 8 | 9 |
| 0 | 5 ms | D | S | U | U | U | D | S | U | U | U |
| 1 | 5 ms | D | S | U | U | D | D | S | U | U | D |
| 2 | 5 ms | D | S | U | D | D | D | S | U | D | D |
| 3 | 10 ms | D | S | U | U | U | D | D | D | D | D |
| 4 | 10 ms | D | S | U | U | D | D | D | D | D | D |
| 5 | 10 ms | D | S | U | D | D | D | D | D | D | D |
| 6 | 5 ms | D | S | U | U | U | D | S | U | U | D |

In Table 1 above, D represents a DL subframe, U represents a UL subframe, and S represents a special subframe. The special subframe includes a downlink pilot timeslot (DwPTS), a guard period (GP), and an uplink pilot timeslot (UpPTS). Table 2 below shows a special subframe configuration.

TABLE 2

| | Normal cyclic prefix in downlink | | | Extended cyclic prefix in downlink | | |
|---|---|---|---|---|---|---|
| | | UpPTS | | | UpPTS | |
| Special | | Normal | Extended | | Normal | Extended |
| subframe | | cyclic prefix | cyclic prefix | | cyclic prefix | cyclic prefix |
| configuration | DwPTS | in uplink | in uplink | DwPTS | in uplink | in uplink |
| 0 | 6592 · T_{S} | 2192 · T_{S} | 2560 · T_{S} | 7680 · T_{S} | 2192 · T_{S} | 2560 · T_{S} |
| 1 | 19760 · T_{S} | | | 20480 · T_{S} | | |
| 2 | 21952 · T_{S} | | | 23040 · T_{S} | | |
| 3 | 24144 · T_{S} | | | 25600 · T_{S} | | |
| 4 | 26336 · T_{S} | | | 7680 · T_{S} | 4384 · T_{S} | 5120 · T_{S} |
| 5 | 6592 · T_{S} | 4384 · T_{S} | 5120 · T_{S} | 20480 · T_{S} | | |
| 6 | 19760 · T_{S} | | | 23040 · T_{S} | | |
| 7 | 21952 · T_{S} | | | — | — | — |
| 8 | 24144 · T_{S} | | | — | — | — |

The above-described radio frame structure is purely exemplary and thus the number of subframes in a radio frame, the number of slots in a subframe, or the number of symbols in a slot may vary in different ways.

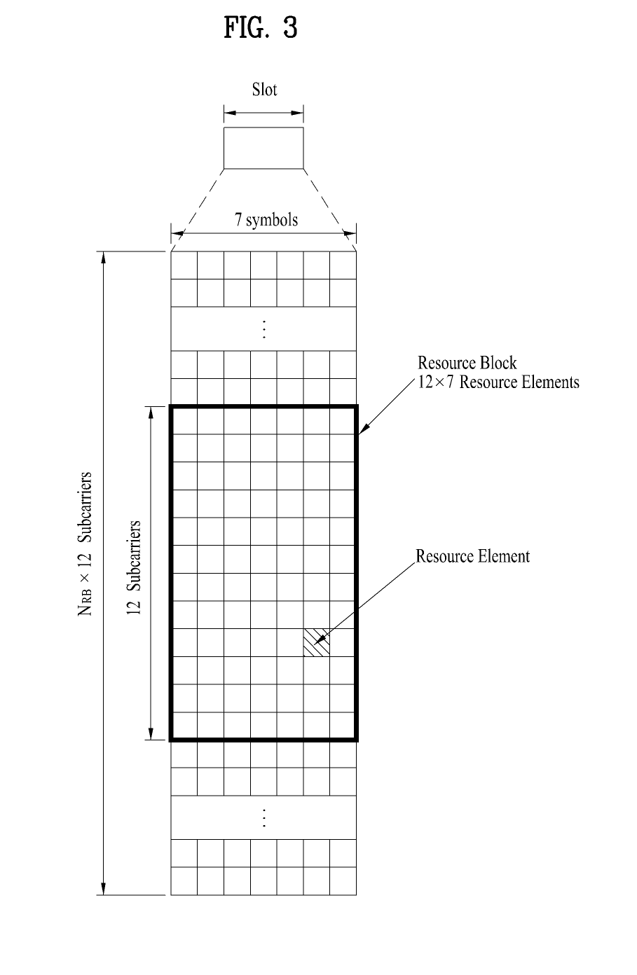

FIG. 3 illustrates a resource grid of one DL slot used in an LTE(-A) system.

Referring to FIG. 3, a DL slot includes a plurality of OFDM symbols in the time domain. One DL slot may include 7 OFDM symbols and a resource block (RB) may include 12 subcarriers in the frequency domain. However, the present invention is not limited thereto. Each element of the resource grid is referred to as a Resource Element (RE). An RB includes 12×7 REs. The number of RBs in a DL slot, N^{DL} depends on a DL transmission bandwidth. A UL slot may have the same structure as a DL slot.

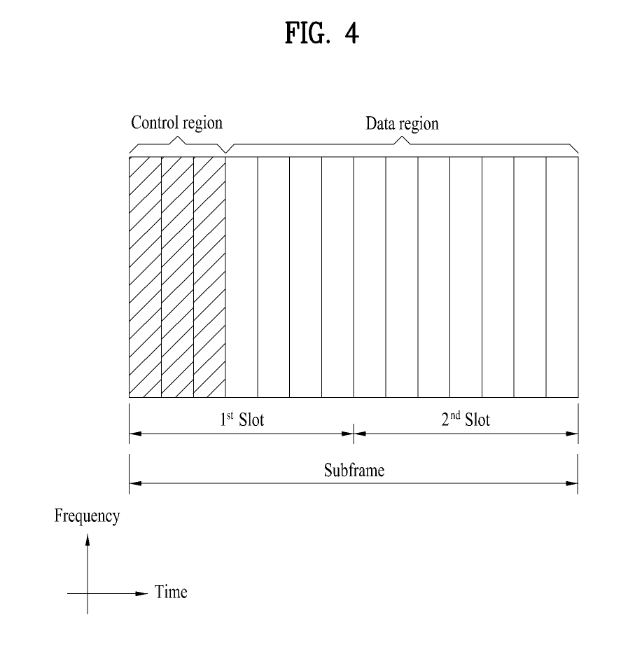

FIG. 4 illustrates a downlink subframe structure used in the LTE(-A) system.

Referring to FIG. 4, a maximum of three (four) OFDM symbols located in a front portion of a first slot within a subframe correspond to a control region to which a control channel is allocated. The remaining OFDM symbols correspond to a data region to which a physical downlink shared chancel (PDSCH) is allocated. A basic resource unit of the data region is RB. Examples of downlink control channels used in the LTE(-A) system include a physical control format indicator channel (PCFICH), a physical downlink control channel (PDCCH), a physical hybrid ARQ indicator channel (PHICH), etc.

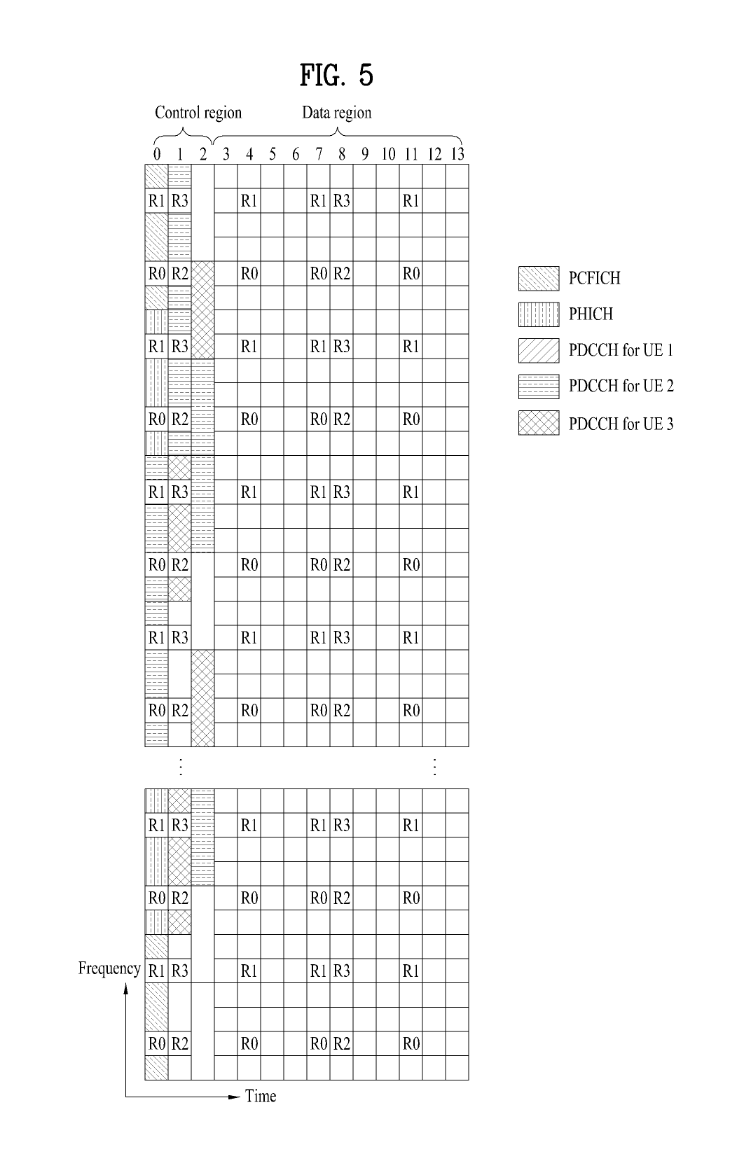

FIG. 5 illustrates a control channel allocated to a downlink subframe. In FIG. 5, R1 to R4 denote a cell-specific reference signal (CRS) or a cell-common reference signal for antenna ports 0 to 3. The CRS is transmitted in all bands every subframe and fixed in a predetermined pattern in a subframe. The CRS is used to channel measurement and downlink signal demodulation.

Referring to FIG. 5, the PCFICH is transmitted at a first OFDM symbol of a subframe and carries information regarding the number of OFDM symbols used for transmission of control channels within the subframe. The PCFICH is composed of four REGs that are uniformly distributed in a control region based on a cell ID. The PCFICH indicates a value of 1 to 3 (or 2 to 4) and is modulated via quadrature phase shift keying (QPSK).

The PHICH is a response of uplink transmission and carries an HARQ acknowledgment (ACK)/not-acknowledgment (NACK) signal. The PHICH except for CRS and PCFICH (a first OFDM symbol) is allocated on the remaining REGs in one or more OFDM symbols configured by PHICH duration. The PHICH is allocated to three REGs that are distributed if possible on the frequency domain.

In LTE system, one PHICH carries 1-bit ACK/NACK signal for PUSCH transmission (or a single data stream) of one user equipment. 1-bit ACK/NACK signal may be coded to 3 bits by using repetition coding of code rate ⅓. ACK/NACK signal through PHICH may be modulated using binary phase shift keying (BPSK). A symbol after modulation may be spread using a spreading factor=4 in case of normal CP or using a spreading factor=2 in case of extended CP. The number of orthogonal sequences used for spreading becomes (spreading factor)*2 by applying I/Q multiplexing. (spreading factor)*2 PHICHs spread using (spreading factor)*2 orthogonal sequences may be defined as one PHICH group. The PHICH group is layer-mapped, precoded, and then mapped to resources and transmitted.

The PDCCH is allocated in first n OFDM symbols (hereinafter, a control region) of a subframe. Here, n is an integer equal to or greater than 1 and is indicated by the PCFICH. Control information transmitted through the PDCCH is referred to as downlink control information (DCI). DCI format is defined as formats 0, 3, 3A, and 4 for uplink and defined as formats 1, 1A, 1B, 1C, 1D, 2, 2A, 2B, 2C, and 2D for downlink. DCI format optionally includes information about hopping flag, RB allocation, modulation coding scheme (MCS), redundancy version (RV), new data indicator (NDI), transmit power control (TPC), cyclic shift demodulation reference signal (DM-RS), channel quality information (CQI) request, HARQ process number, transmitted precoding matrix indicator (TPMI), precoding matrix indicator (PMI) confirmation, etc. according to its usage.

A PDCCH may carry a transport format and a resource allocation of a downlink shared channel (DL-SCH), resource allocation information of an uplink shared channel (UL-SCH), paging information on a paging channel (PCH), system information on the DL-SCH, information on resource allocation of an upper-layer control message such as a random access response transmitted on the PDSCH, a set of Tx power control commands on individual UEs within an arbitrary UE group, a Tx power control command, information on activation of a voice over IP (VoIP), etc. The BS determines a PDCCH format according to DCI to be transmitted to the UE, and attaches a cyclic redundancy check (CRC) to control information. The CRC is masked with a unique identifier (referred to as a radio network temporary identifier (RNTI)) according to an owner or usage of the PDCCH. If the PDCCH is for a specific UE, a unique identifier (e.g., cell-RNTI (C-RNTI)) of the UE may be masked to the CRC. Alternatively, if the PDCCH is for a paging message, a paging identifier (e.g., paging-RNTI (P-RNTI)) may be masked to the CRC. If the PDCCH is for system information (more specifically, a system information block (SIB)), a system information RNTI (SI-RNTI) may be masked to the CRC. When the PDCCH is for a random access response, a random access-RNTI (RA-RNTI) may be masked to the CRC.

UE may monitor a plurality of PDCCHs. A plurality of PDCCHs may be transmitted in one subframe. The LTE(-A) system defines a limited set of resource positions in which a PDCCH is to be positioned for each UE. A limited set of resource positions that a UE can find a PDCCH of the UE may be referred to as a search space (SS). In the LTE(-A) system, the SS has different sizes according to each PDCCH format. In addition, a UE-specific SS and a common SS are separately defined. The BS does not provide the UE with information indicating where the PDCCH is located in the control region. Accordingly, the UE monitors a set of PDCCH candidates within the subframe and finds its own PDCCH. The term “monitoring” means that the UE attempts to decode the received PDCCHs according to respective DCI formats. The monitoring for a PDCCH in an SS is referred to as blind decoding (blind detection). Through blind decoding, the UE simultaneously performs identification of the PDCCH transmitted to the UE and decoding of the control information transmitted through the corresponding PDCCH. For example, in the case where the PDCCH is de-masked using the C-RNTI, the UE detects its own PDCCH if a CRC error is not detected. The USS is separately configured for each UE and a scope of CSSs is known to all UEs.

In general, the UE searches for formats 0 and 1A at all times in the UE-specific search space. Formats 0 and 1A have the same size and are discriminated from each other by a flag in a message. The UE may need to receive an additional format (e.g. format 1, 1B or 2 according to PDSCH transmission mode set by a BS). The UE searches for formats 1A and 1C in the UE-common search space. Furthermore, the UE may be set to search for format 3 or 3A. Formats 3 and 3A have the same size as that of formats 0 and 1A and may be discriminated from each other by scrambling CRC with different (common) identifiers rather than a UE-specific identifier. A PDSCH transmission scheme and information contents of DCI formats according to a transmission mode will be listed below.

Transmission Mode (TM)
Transmission Mode 1: Transmission from a single eNB antenna port
Transmission Mode 2: Transmit diversity
Transmission Mode 3: Open-loop spatial multiplexing
Transmission Mode 4: Closed-loop spatial multiplexing
Transmission Mode 5: Multi-user MIMO
Transmission Mode 6: Closed-loop rank-1 precoding
Transmission Mode 7: Single-antenna port (port 5) transmission
Transmission Mode 8: Dual layer transmission (ports 7 and 8) or single-antenna port (port 7 or 8) transmission
Transmission Modes 9 and 10: Layer transmission up to rank 8 (ports 7 to 14) or single-antenna port (port 7 or 8) transmission

DCI Format
Format 0: Resource grant for PUSCH transmission (uplink)
Format 1: Resource allocation for single codeword PUSCH transmission (transmission modes 1, 2, and 7)
Format 1A: Compact signaling of resource allocation for single codeword PDSCH transmission (all modes)
Format 1B: Compact resource allocation for PDSCH (mode 6) using rank-1 closed-loop precoding
Format 1C: Very compact resource allocation for PDSCH (e.g., paging/broadcast system information)
Format 1D: Compact resource allocation for PDSCH (mode 5) using multi-user MIMO
Format 2: Resource allocation for PDSCH (mode 4) of closed-loop MIMO operation
Format 2A: Resource allocation for PDSCH (mode 3) of open-loop MIMO operation
Format 3/3A: Power control command with 2-bit/1-bit power adjustments for PUCCH and PUSCH
Format 4: Resource grant for PUSCH transmission (uplink) in a cell configured in a multi-antenna port transmission mode

A UE may be semi-statically configured via higher layer signaling for reception of PDSCH data transmission that is scheduled through the PDCCH according to ten transmission modes. Table 5 below shows a transmission mode signaled via a higher layer and configurable DCI format when a UE detects a scrambled PDCCH as a C-RNTI identifier.

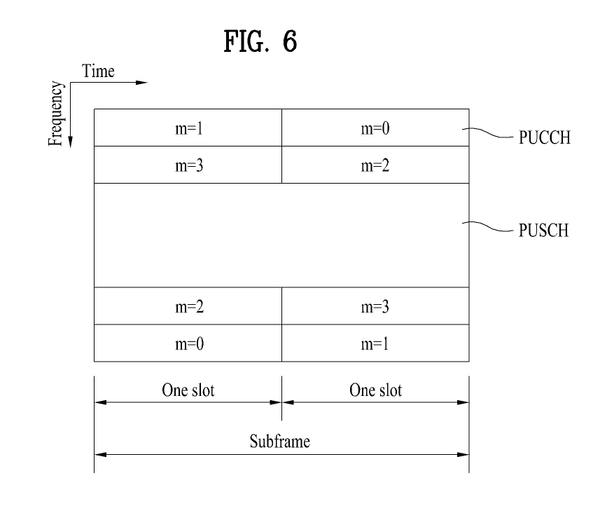

FIG. 6 illustrates a structure of a UL subframe in the LTE(-A) system.

Referring to FIG. 6, a UL subframe includes a plurality of (e.g. 2) slots. A slot may include a different number of SC-FDMA symbols according to a CP length. The UL subframe is divided into a control region and a data region in the frequency domain. The data region includes a PUSCH to transmit a data signal such as voice and the control region includes a PUCCH to transmit UCI. The PUCCH occupies a pair of RBs at both ends of the data region on a frequency axis and the RB pair frequency-hops over a slot boundary.

The PUCCH may deliver the following control information.
Scheduling request (SR): information requesting UL-SCH resources. An SR is transmitted in On-Off Keying (OOK).
HARQ ACK/NACK: a response signal to a DL data packet received on a PDSCH, indicating whether the DL data packet has been received successfully. A 1-bit ACK/NACK is transmitted as a response to a single DL codeword and a 2-bit ACK/NACK is transmitted as a response to two DL codewords.
CSI: feedback information regarding a DL channel. CSI includes a CQI and Multiple Input Multiple Output (MIMO)-related feedback information includes an RI, a PMI, a Precoding Type Indicator (PTI), etc. The CSI occupies 20 bits per subframe.

Table 3 below illustrates a mapping relationship between PUCCH formats and UCI in the LTE system.

TABLE 3

| PUCCH | |
|---|---|
| format | Uplink Control Information, UCI |
| Format 1 | SR(Scheduling Request) (un-modulated waveform) |
| Format 1a | 1-bit HARQ ACK/NACK (with/without SR) |
| Format 1b | 2-bit HARQ ACK/NACK (with/without SR) |
| Format 2 | CSI (20 coded bits) |
| Format 2 | CSI and ½-bit HARQ ACK/NACK (20 bits)(Extended CP only) |
| Format 2a | CSI and 1-bit HARQ ACK/NACK (20 + 1 coded bits) |
| Format 2b | CSI and 2-bit HARQ ACK/NACK (20 + 2 coded bits) |
| Format 3 | HARQ ACK/NACK + SR (48 bits) |
| (LTE-A) | |

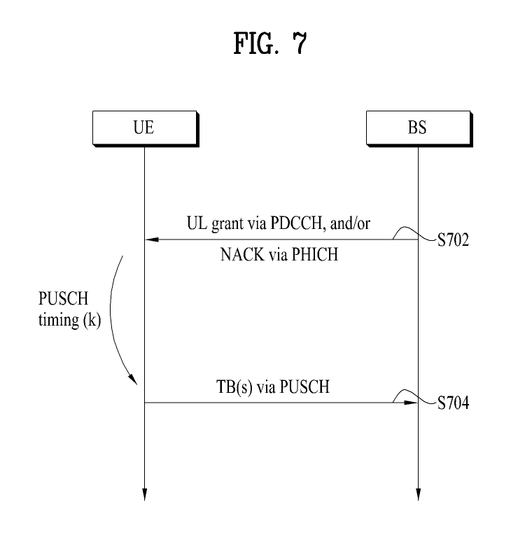

FIG. 7 illustrates an example of PHICH/UL grant (UG)-PUSCH timing. PUSCH can be transmitted in response to PDCCH (UL grant) and/or PHICH (NACK).

Referring to FIG. 7, a user equipment can receive PDCCH (UL grant) and/or PHICH (NACK) (S702). In this case, NACK corresponds to ACK/NACK response for a previous PUSCH transmission. In this case, a user equipment undergoes a process (e.g., transport block (TB) coding, transport block-codeword (CW) swapping, PUSCH resource allocation and the like) for PUSCH transmission and may be able to initially transmit/retransmit one or a plurality of transport blocks via PUSCH after a k subframe (S704). The present example assumes a normal HARQ operation that transmits PUSCH one time. In this case, PHICH/UL grant corresponding to the PUSCH transmission exists in an identical subframe. Yet, in case of performing subframe bundling in a manner that PUSCH is transmitted several times via a plurality of subframes, the PHICH/UL grant corresponding to the PUSCH transmission may exist in a subframe different from each other.

Specifically, if the PHICH/UL grant is detected in a subframe n, a user equipment can transmit PUSCH in a subframe n+k. in case of FDD system, k may have a fixed value (e.g., 4). In case of TDD system, k may have a different value according to a UL-DL configuration. Table 4 shows an UAI (uplink association index) (k) for PUSCH transmission in TDD LTE(-A) system.

TABLE 4

| TDD | subframe number n | | | | | | | | | |
|---|---|---|---|---|---|---|---|---|---|---|
| UL/DL Configuration | 0 | 1 | 2 | 3 | 4 | 5 | 6 | 7 | 8 | 9 |
| 0 | 4 | 6 | | | | 4 | 6 | | | |
| 1 | | 6 | | | 4 | | 6 | | | 4 |
| 2 | | | | 4 | | | | | 4 | |
| 3 | 4 | | | | | | | | 4 | 4 |
| 4 | | | | | | | | | 4 | 4 |
| 5 | | | | | | | | | 4 | |
| 6 | 7 | 7 | | | | 7 | 7 | | | 5 |

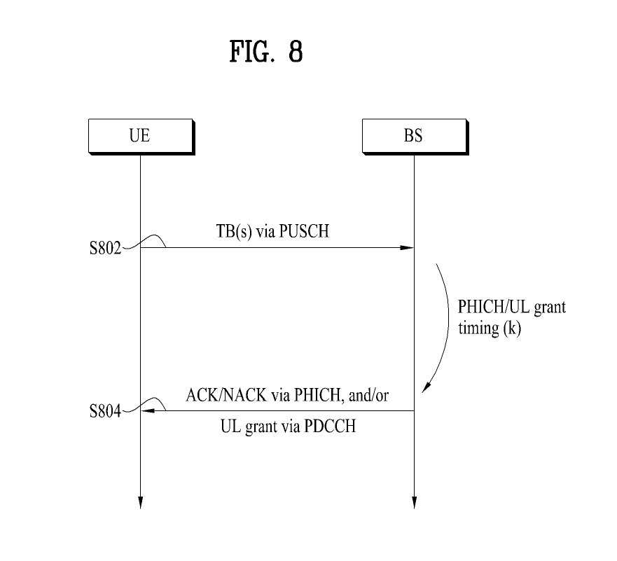

FIG. 8 illustrates an example of PUSCH-PHICH/UL grant timing. PHICH is used to transmit DL ACK/NACK. In this case, the DL ACK/NACK indicates ACK/NACK transmitted in DL in response to UL data (e.g., PUSCH).

Referring to FIG. 8, a user equipment transmits a PUSCH signal to a base station (S802). In this case, the PUSCH signal is used to transmit one or a plurality of (e.g., 2) transport blocks (TBs) according to a transmission mode. A base station undergoes a process (e.g., ACK/NACK generation, ACK/NACK resource allocation and the like) to transmit ACK/NACK and may be then able to transmit the ACK/NACK to a user equipment via PHICH after a k subframe in response to the PUSCH transmission (S804). The ACK/NACK includes reception response information on the PUSCH signal of the step S702. If a response for the PUSCH transmission corresponds to NACK, a base station can transmit UL grant PDCCH to a user equipment to transmit PUSCH again after the k subframe (S804). The present example assumes a normal HARQ operation that transmits PUSCH one time. In this case, PHICH/UL grant corresponding to the PUSCH transmission can be transmitted in an identical subframe. Yet, in case of performing subframe bundling, the PHICH/UL grant corresponding to the PUSCH transmission can be transmitted in a subframe different from each other.

Specifically, the PHICH/UL grant of a subframe i corresponds to PUSCH transmitted in a subframe i−k. In case of TDD system, k may have a different value according to a UL-DL configuration. Table 5 shows an UAI (uplink association index) (k) for PUSCH transmission in LTE(-A) system. Table 5 shows an interval between a DL subframe and a UL subframe associated with the DL subframe in terms of the DL subframe in which PHICH/UL grant exists.

TABLE 5

| TDD | subframe number i | | | | | | | | | |
|---|---|---|---|---|---|---|---|---|---|---|
| UL/DL Configuration | 0 | 1 | 2 | 3 | 4 | 5 | 6 | 7 | 8 | 9 |
| 0 | 7 | 4 | | | | 7 | 4 | | | |
| 1 | | 4 | | | 6 | | 4 | | | 6 |
| 2 | | | | 6 | | | | | 6 | |
| 3 | 6 | | | | | | | | 6 | 6 |
| 4 | | | | | | | | | 6 | 6 |
| 5 | | | | | | | | | 6 | |
| 6 | 6 | 4 | | | | 7 | 4 | | | 6 |

In the following, PHICH resource allocation is explained. If PUSCH is transmitted in a subframe #n, a user equipment determines a corresponding PHICH resource in a subframe #(n+k_{PHICH}). In FDD system, k_{PHICH} has a fixed value (e.g., 4). In TDD system, k_{PHICH} has a different value according to UL-DL configuration. Table 6 shows a k_{PHICH} value for TDD.

TABLE 6

| TDD | UL subframe index n | | | | | | | | | |
|---|---|---|---|---|---|---|---|---|---|---|
| UL/DL Configuration | 0 | 1 | 2 | 3 | 4 | 5 | 6 | 7 | 8 | 9 |
| 0 | | | 4 | 7 | 6 | | | 4 | 7 | 6 |
| 1 | | | 4 | 6 | | | | 4 | 6 | |
| 2 | | | 6 | | | | | 6 | | |
| 3 | | | 6 | 6 | 6 | | | | | |
| 4 | | | 6 | 6 | | | | | | |
| 5 | | | 6 | | | | | | | |
| 6 | | | 4 | 6 | 6 | | | 4 | 7 | |

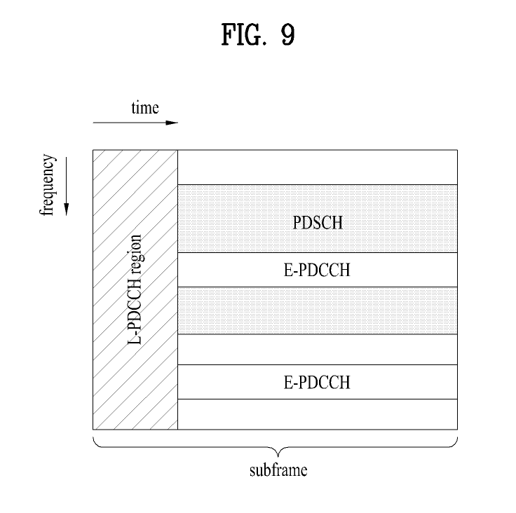

FIG. 9 illustrates an example in which a DL physical channel is allocated in a subframe.

Referring to FIG. 9, a PDCCH (for convenience, legacy PDCCH or L-PDCCH) used in the LTE(-A) system may be allocated to a control region (refer to FIG. 5) of a subframe. In FIG. 9, an L-PDCCH region refers to a region to which the legacy PDCCH is allocated. In the context, the L-PDCCH region may refer to a control region, a control channel resource region to which a PDCCH can be actually allocated, or a PDCCH search space. A PDCCH may be additionally allocated in a data region (e.g., a resource region for a PDSCH, refer to FIG. 5). The PDCCH allocated to the data region is referred to as an E-PDCCH. As illustrated in FIG. 9, a control channel resource may be additionally allocated through the E-PDCCH to alleviate scheduling restrictions due to limited control channel resource of an L-PDCCH region.

In detail, the E-PDCCH may be detected/demodulated based on a DM-RS. The E-PDCCH may be configured to be transmitted over a PRB pair on the time axis. In more detail, a search space (SS) for E-PDCCH detection may be configured with one or more (e.g., 2) E-PDCCH candidate sets. Each E-PDCCH set may occupy a plurality of (e.g., 2, 4, or 8) PRB pairs. An enhanced-CCE (E-CCE) constituting an E-PDCCH set may be mapped in the localized or distributed form (according to whether one E-CCE is distributed in a plurality of PRB pairs). In addition, when E-PDCCH based scheduling is configured, a subframe for transmission/detection of an E-PDCCH may be determined The E-PDCCH may be configured in only a USS. The UE may attempt DCI detection only on an L-PDCCH CSS and an E-PDCCH USS in a subframe (hereinafter, an E-PDCCH subframe) in which E-PDCCH transmission/detection is configured and attempt DCI detection on an L-PDCCH CSS and an L-PDCCH USS in a subframe (non-E-PDCCH subframe) in which transmission/detection of E-PDCCH is not configured.

In the LTE system and LTE-A system, a series of processes for scheduling UEs by an eNB and transmitting and receiving data to and from the UEs through the eNB are performed for communication between the UEs. On the other hand, a communication method for directly transmitting and receiving data to and from UEs without an eNB is referred to as device-to-device (D2D) communication. In a D2D communication system, data is directly transmitted between UEs but control of an eNB may be partially performed. The present invention proposes a D2D data scheduling/transmitting procedure and a feedback procedure appropriate therefor in this D2D communication situation. For convenience of description, devices that perform D2D data transmitting/receiving operations on a D2D communication link may be referred to as a transmitting device or transmitter device (TD) and a receiving device or a receiver device (RD), respectively. The type of the PDCCH stated according to the present invention may be based on an E-PDCCH manner as well as an L-PDCCH method. In addition, for convenience of description, although the present invention will be described using a PDCCH, a PDSCH, a PHICH, and a PUCCH, a channel/signal corresponding to each of the PDCCH, the PDSCH, the PHICH, and the PUCCH can be replaced with another title of channel/signal that performs the same function.

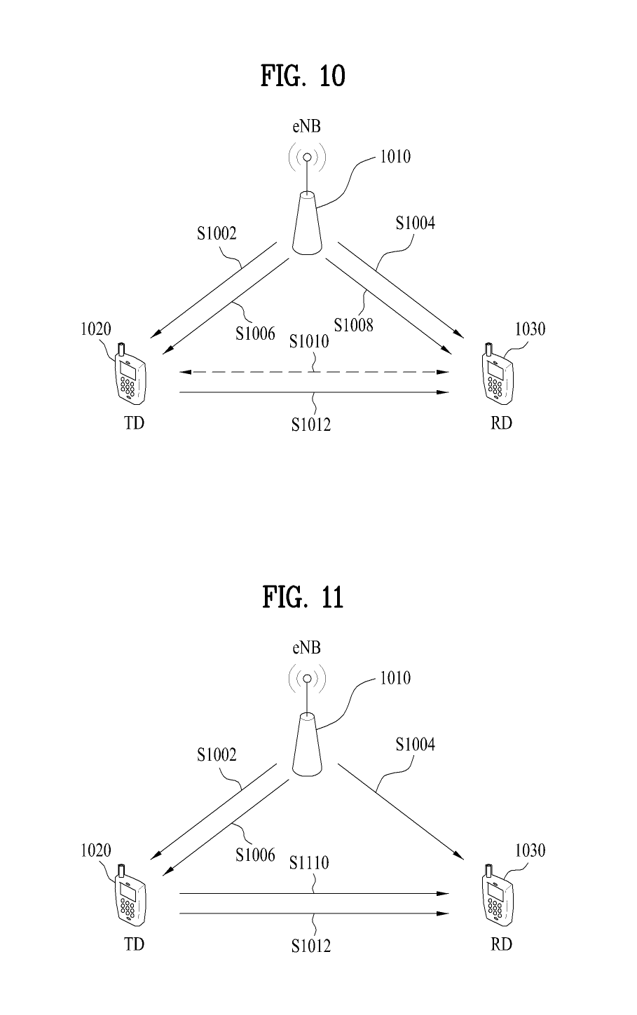

FIG. 10 illustrates an example of a D2D data scheduling/transmitting procedure to be performed in a D2D communication situation that can be generally considered.

Referring to FIG. 10, an eNB 1010 may semi-statically pre-configure control information/parameters, etc. required for D2D communication to D2D UEs 1020 and 1030 via higher layer signaling (e.g., RRC signaling) (S1002 and S1004). For example, the control information/parameters required for D2D communication may include information about a subframe set (referred to as a “D2D SF set”) in which D2D signal transmission is possible/permitted and/or information about a subframe set (referred to as a “D2D-BD SF set”) in which signaling of D2D scheduling information transmitted and received between D2D UEs can be performed/detected (e.g., blind-detected (BD)). For example, the D2D-BD SF set may be configured as a specific subset of the D2D SF set.

Then the eNB 1010 may dynamically transmit a specific control signal/channel or data channel for triggering D2D scheduling at a specific time point to the TD 1020 and the RD 1030 (S1006 and S1008). In this case, the control signal/channel for triggering D2D scheduling may be transmitted through, for example, a PDCCH and the data channel for triggering D2D scheduling through, for example, a PDSCH. For convenience, in this specification, the specific control signal/channel or data channel for triggering D2D scheduling is referred to as a D2D trigger.

The TD 1020 and the RD 1030 that receive the D2D trigger may perform a D2D data transmitting and receiving operation to the RD 1030 from the TD 1020 based on D2D communication control information/parameter that is pre-configured via higher layer signaling and D2D scheduling control information in the D2D trigger (S1012). In this case, detailed D2D scheduling information such as resource allocation information, a modulation and coding scheme (MCS), and/or a size of a transport block (TB) for D2D data transmission and reception may be transmitted and received between the D2D UEs (TD and RD) 1020 and 1030 (S1010). For example, the detailed D2D scheduling information for D2D data transmission and reception may be signaled to the RD 1030 from the TD 1020 or signaled to the TD 1020 from the RD 1030. Then the RD 1030 may transmit ACK/NACK feedback to D2D data reception to the eNB 1010 or the TD 1020.

In the example of FIG. 10, operation S1010 may be performed at the same time point as operation S1012 or performed at a specific time point prior to operation S1012.

The D2D data scheduling/transmitting procedure illustrated in FIG. 10 may be appropriate for, for example, the case in which a stable link between an eNB and TD/RD is ensured. In this specification, a link may be a communication channel configured between a transmitter and a receiver and referred to as a radio link.

FIG. 11 illustrates an example of a D2D data scheduling/transmitting procedure to be performed in another D2D communication situation.

Referring to FIG. 11, the eNB 1010 may semi-statically pre-configure control information/parameters required for D2D communication to the D2D UEs 1020 and 1030 via higher layer signaling (e.g., RRC signaling) (S1002 and S1004). For example, the control information/parameters required for D2D communication may include information about a D2D SF set in which D2D signal transmission is possible/permitted and/or information about a D2D-BD SF set in which signaling of D2D scheduling information transmitted and received between D2D UEs can be performed/detected (e.g., blind-detected (BD)). For example, the D2D-BD SF set may be configured as a specific subset of the D2D SF set.

Then the eNB 1010 may dynamically transmit a D2D trigger for triggering D2D scheduling at a specific time point only to the TD 1020 (S1006). As described above, the D2D trigger may be transmitted through a specific control signal/channel such as a PDCCH, etc. or a data channel such as a PDSCH, etc.

After receiving a D2D trigger, the TD 1020 may signal detailed D2D scheduling information for D2D data transmission and reception to the RD 1030 based on pre-configured D2D communication control information/parameters and D2D scheduling in the D2D trigger, in a specific subframe of the D2D-BD SF set (S1110). The detailed D2D scheduling information may include information such as resource allocation information, modulation and coding scheme (MCS), and/or a size of transport block (TB).

In a specific subframe of the D2D SF set, the TD 1020 may perform a D2D data transmission operation to the RD 1030 (S1012). In this case, the RD 1030 may attempt to detect/receive D2D scheduling information signaling for a designated D2D-BD SF set. As described above, a specific subset of the D2D SF set may be configured as a D2D-BD SF set. Then the RD 1030 may transmit ACK/NACK feedback to D2D data reception to the eNB 1010 or the TD 1020.

Although FIG. 11 illustrates the case in which operations S1110 and S1012 are performed at different time points, operations S1110 and S1012 may be performed at the same time point.

The D2D data scheduling/transmitting procedure illustrated in FIG. 11 may be appropriate for, for example, the case in which a stable link between a TD and an eNB is ensured but a stable link between an RD and the eNB is not ensured. For example, when the RD is outside eNB coverage, a stable link between the RD and the eNB may not be ensured.

In a D2D communication system, an ACK/NACK feedback transmission method for D2D data may include a method for transmitting the D2D data to an eNB from an RD and a method for transmitting the D2D data to a TD from the RD. For convenience, a method for transmitting ACK/NACK feedback to D2D data reception to an eNB from an RD is referred to as an A/N-to-eNB method and a method for transmitting ACK/NACK feedback to D2D data reception to the TD from the RD is referred to as an A/N-to-TD method. The present invention proposes D2D feedback procedures appropriate for the respective ACK/NACK feedback transmission methods.

D2D Feedback Procedure Based on A/N-to-eNB Method

In the A/N-to-eNB method, after D2D scheduling, an eNB may receive ACK/NACK feedback to D2D data reception from an RD. When the ACK/NACK feedback is ACK, no problem occurs, but when the ACK/NACK feedback is NACK, it may be difficult to determine the reason. For example, when the ACK/NACK feedback is NACK, the reason may corresponds to the case in which (i) although a TD transmits D2D data, receiving errors arise in an RD, or (ii) although the TD does not transmit D2D data, the RD determines receiving errors, and thus the reason may be ambiguous. Thus, upon receiving NACK, the eNB may have difficulty in determining whether link performance between the TD and the RD needs to be supplemented or link performance between the eNB and the TD needs to be supplemented. For example, in order to supplement the link performance between the TD and the RD, power/resource/MCS/RV, etc. for D2D data transmission may be adjusted. In addition, for example, in order to supplement the link performance between the eNB and the TD, power/resource/MCS/RV, etc. for D2D trigger transmission may be adjusted.

To overcome this problem, the present invention proposes a method of feeding back information about whether the TD actually transmits D2D data to the RD based on D2D scheduling information received from the eNB, to the eNB. For convenience of description, a signal about whether D2D data is transmitted, which is fed back to an eNB by a TD, is referred to as “TX feedback”.

In detail, TX feedback may have two states similarly to ACK/NACK feedback fed back to an eNB from an RD. For example, the two states for the TX feedback may include TX success or TX failure. In addition, for example, when the TD performs D2D data transmission to the RD, the TX success may be signaled to the eNB, and when the TD does not perform D2D data transmission to the RD, the TX failure may be signaled to the eNB. For example, the TX failure may be useful to the case in which a TD gives up D2D data transmission in order to transmit and receiving a signal/channel with higher priority than D2D data although the TD properly receives a D2D trigger. A signal/channel used for the TX feedback may have the same/similar format (e.g., PUCCH format 1a/1b) to a signal/channel for ACK/NACK feedback. For example, different TX feedback states may be mapped to positions of ACK and NACK on constellation. In addition, TX feedback may be transmitted after D2D data is transmitted. In addition, the TX feedback may be transmitted at the same time point as ACK/NACK feedback based on the A/N-to-eNB method or transmitted at a time point prior to ACK/NACK feedback.

In the A/N-to-eNB method, since ACK/NACK feedback to D2D data is transmitted to an eNB, but not to the TD, from the RD, the TD cannot recognize whether reception/decoding in the RD is successful with respect to transmitted D2D data. Thus, the TD needs to unnecessarily continuously store the D2D data in a transmission buffer for a predetermined period of time and needs to also allow hardware required for a D2D transmission operation (e.g., SC-FDM modulation based transmission) to wait while being continuously driven, which may not be appropriate in terms of buffer usage efficiency and power consumption reduction.

To overcome this problem, the present invention proposes that an eNB feedback information about whether the RD succeeds in receiving/decoding D2D data to a TD and/or an RD based on ACK/NACK feedback from the RD. For convenience, a signal that is fed back to the TD and/or the RD from the eNB in order to indicate whether D2D data reception/decoding are successful is referred to as “RX feedback”.

In detail, the RX feedback may have two states similarly to ACK/NACK feedback fed back to an eNB from an RD. For example, the two states for the RX feedback may include RX success or RX failure. In addition, for example, when the RD succeeds in receiving/decoding D2D data, the RX success may be signaled to the TD. The case in which the RD succeeds in receiving/decoding D2D data may include, for example, the case in which ACK/NACK feedback is ACK. In addition, for example, when the RD fails in receiving/decoding D2D data, the RX failure may be signaled to the TD. The case in which the RD fails in receiving/decoding D2D data may include, for example, the case in which ACK/NACK feedback is NACK and/or discontinuous transmission (DTX). The DTX may include the case in which detection of ACK/NACK feedback signal from the RD fails and/or the case in which the RD fails in detecting D2D scheduling information signaling from the TD.

Alternatively, the RX feedback may have three states. For example, the three states for the RX feedback may include RX success, RX fail-wait, and RX fail-retx. The RX success may be the same as the aforementioned RX success. The RX fail-wait may be signaled to the TD when the RD fails in receiving/decoding D2D data. In this case, the TD may attempt to detect a D2D trigger for retransmission of D2D data without automatic retransmission of the D2D data. The RX fail-retx may be signaled to the TD when the RD fails in receiving/decoding the D2D data. In this case, the TD may automatically retransmit the D2D data based on a most recently received D2D trigger. The case in which the RD fails in receiving/decoding the D2D data may include, for example, the case in which ACK/NACK feedback is NACK.

A signal/channel used for the RX feedback may be a PDCCH having, for example, the same or similar format to a DCI format (e.g., DCI format 3/3A) for PHICH or UL power control. For example, 2-state RX feedback can be represented by one bit, and thus one bit can be allocated/used in one PHICH resource or DCI format 3/3A. As another example, 3-state RX feedback can be represented by two bits, and thus two bits can be allocated/used in two PHICH resources or DCI format 3/3A. When a PDCCH (e.g., DCI format 3/3A) is used, each RX feedback state may be configured or divided using a combination of the bits values. When a PHICH is used, each RX feedback state may be configured or divided using a combination of ACK/NACK modulation symbols on each PHICH resource.

Although the TX feedback and the RX feedback have been separately described thus far, the TX feedback and the RX feedback can simultaneously applied for management of eNB-TD/RD and TD-RD link and buffer and power management of a D2D UE.

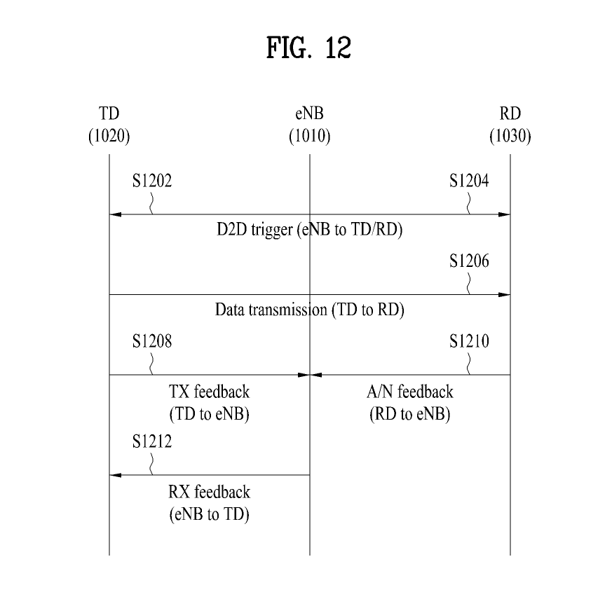

FIG. 12 illustrates an example of a D2D feedback procedure according to the present invention. In the example of FIG. 12, it is assumed that the eNB 1010 semi-statically pre-configures control information/parameters required for D2D communication to the D2D UEs 1020 and 1030 via higher layer signaling (e.g., RRC signaling) (refer to S1002 and S1004 of FIG. 10 or 11).

As described with reference to FIG. 10, in operations S1202 and S1204, the eNB 1010 may dynamically transmit a D2D trigger to the TD 1020 and the RD 1030 at a specific time point (refer to S1006 and S1008 of FIG. 10). Alternatively, as described with reference to FIG. 11, the eNB 1010 may dynamically transmit a D2D trigger only to the TD 1020 at a specific time point (refer to S1006 of FIG. 11). In this case, operation S1204 may not be performed. As described above, the D2D trigger may be transmitted through, for example, a PDCCH or a PDSCH.

In operation S1206, the TD 1020 may transmit D2D data to the RD 1030. The D2D transmission to the RD 1030 from the TD 1020 may be based on D2D communication control information/parameters pre-configured via higher layer signaling and D2D scheduling control information in a D2D trigger.

In addition, as described with reference to FIGS. 10 and 11, simultaneously with operation S1206 or prior to operation S1206, the TD 1020 may signal detailed D2D scheduling information such as resource allocation information, a modulation and coding scheme (MCS), and/or a size of a transport block (TB) for D2D data transmission and reception, to the RD 1030.

In operation S1208, the TD 1020 may transmit TX feedback to the eNB 1010. As described above, the TX feedback may include information about whether the TD actually transmits D2D data to the RD. In addition, the TX feedback may include a plurality of state information and for example, include two state information such as TX success and TX failure.

In operation S1210, the RD 1030 may transmit ACK/NACK feedback to D2D data to the eNB 1010. The ACK/NACK feedback may indicate whether the RD succeeds in receiving/decoding the D2D data transmitted from the TD. The ACK/NACK feedback may include, for example, two state information such as ACK and NACK or three state information such as ACK, NACK, and DTX.

As described above, operations S1208 and S1210 may be performed at the same time point. Alternatively, operations S1208 and S1210 may be performed at different time points. For example, operation S1208 may be performed prior to operation S1210.

In operation S1212, the eNB 1010 may transmit RX feedback to the TD 1020. As described above, the RX feedback may include information about whether D2D data reception/decoding fed back to the TD and/or the RD are successful. In addition, the RX feedback may include a plurality of state information, for example, two state information such as RX success and RX fail or three state information such as RX success, RX fail-wait, and RX fail-retx. Upon receiving RX feedback including RX fail-wait, the TD 1020 may attempt to detect a D2D trigger for retransmission of D2D data without automatic retransmission of the D2D data. Upon receiving RX feedback including RX fail-retx, the TD 1020 may automatically retransmit D2D data based on a most recently received D2D trigger.

D2D Feedback Procedure Based on A/N-to-TD Method

In the A/N-to-TD method, after D2D scheduling, a TD directly receives ACK/NACK feedback to D2D data transmitted to an RD from the TD from the RD. In this case, when an eNB can know an ACK/NACK feedback state, the A/N-to-TD method may also be useful for management of eNB-RD link, management of TD-RD transmission link, and management of RD-TD feedback link as well as for management of scheduling/resource of D2D UEs. For example, when it is assumed that the eNB knows ACK/NACK feedback to D2D data, if ACK/NACK feedback is ACK, the eNB may appropriately re-adjust a D2D scheduling/resource allocation sequence of the TD/RD to, for example, a subordinated sequence. In addition, when the ACK/NACK feedback is NACK, the eNB may supplement D2D data transmission link performance between the TD and the RD (e.g., via adjustment of power/resource/MCS/RV). In addition, in the case of DTX (which corresponds to the case in which ACK/NACK feedback signal detection from the RD fails), the eNB may supplement D2D trigger transmission link between the eNB and RD or ACK/NACK feedback link performance between the RD and the TD (e.g., via adjustment of power/resource/MCS/RV).

To this end, the present invention proposes a method in which the TD transmits ACK/NACK feedback information to D2D data received from the RD by the TD, to the eNB. For convenience, a signal for transmitting ACK/NACK feedback information to the eNB by the TD is referred to as “ACK/NACK forward”.

In detail, the ACK/NACK forward may have two states similarly to ACK/NACK feedback. For example, the two states for the ACK/NACK forward may include D2D-ACK and D2D-NACK. The D2D-ACK may be signaled to the eNB from the TD when the ACK/NACK feedback received from the RD is ACK. The D2D-NACK may be signaled to the eNB from the TD when the ACK/NACK feedback received from the RD is NACK or DTX.

Alternatively, the ACK/NACK forward may have three states. For example, the three states for the ACK/NACK forward may include D2D-ACK, D2D-NACK, or D2D-DTX. The D2D-ACK may be signaled to the eNB from the TD when the ACK/NACK feedback received from the RD is ACK. The D2D-NACK may be signaled to the eNB from the TD when the ACK/NACK feedback received from the RD is NACK. The D2D-DTX may be signaled to the eNB from the TD when the ACK/NACK feedback received from the RD is DTX.

A signal/channel used for the ACK/NACK forward may have the same/similar format (e.g., PUCCH format 1a/1b) to a signal/channel for ACK/NACK feedback. For example, different ACK/NACK forward states may be mapped to positions of ACK and NACK on constellation.

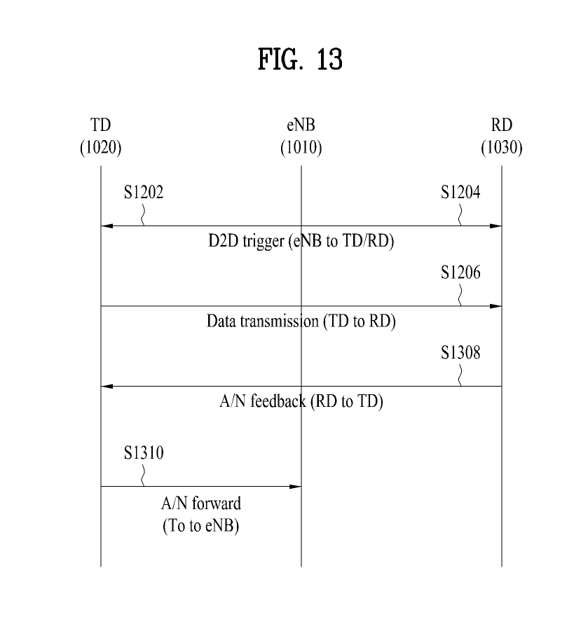

FIG. 13 illustrates an example of a D2D feedback procedure according to the present invention. In the example of FIG. 13, it is assumed that the eNB 1010 may semi-statically pre-configure control information/parameters required for D2D communication to the D2D UEs 1020 and 1030 via higher layer signaling (e.g., RRC signaling) (refer to S1002 and S1004 of FIG. 10 or 11).

Operations S1202, S1204, and S1206 are the same as those described with reference to FIG. 12. Thus, the description of operations S1202, S1204, and S1206 is applied herein. In addition, as described with reference to FIG. 12, simultaneously with operation S1206 or prior to operation S1206, the TD 1020 may signal detailed D2D scheduling information for D2D data transmission and reception to the RD 1030.

In operation S1308, the RD 1030 may transmit ACK/NACK feedback to the TD. As described above, the ACK/NACK feedback may indicate whether the RD succeeds in receiving/decoding the D2D data transmitted from the TD. The ACK/NACK feedback may include, for example, two state information such as ACK and NACK or three state information such as ACK, NACK, and DTX.

In operation S1310, the TD 1020 may transmit ACK/NACK forward to the eNB 1010. As described above, the ACK/NACK forward may refer to feedback information for transmitting ACK/NACK feedback information about D2D data, received from the RD by the TD, to the eNB from the TD. In addition, the ACK/NACK forward may include a plurality of state information, and for example, include two and three state information according to a state of the ACK/NACK feedback received from the RD.

Since a stable link between the RD and the eNB is not ensured in the method illustrated in FIG. 13, the method may be useful when the RD cannot receive a D2D trigger from the eNB or the RD transmits ACK/NACK feedback to D2D data to the eNB. The case in which the stable link between the RD and the eNB is not ensured may include, for example, the case in which the RD is outside coverage of the eNB.

In addition, the method illustrated in FIG. 13 may be useful when overall configuration and/or control required for D2D communication is managed in terms of the eNB and the TD. The case in which overall configuration and/or control required for D2D communication is managed in terms of the eNB and the TD may include, for example, the case in which the TD is used as a relay node between the eNB and the RD.

Thus far, the D2D feedback procedure based on the A/N-to-eNB method and the D2D feedback procedure based on the A/N-to-TD method have been described. The two D2D feedback procedures may be independently performed and some components may be omitted or other components are added during each D2D feedback procedure. In addition, the two D2D feedback procedures may be combined and performed and some components of one D2D feedback procedure may be combined with the other D2D feedback procedure or all components of one D2D feedback procedure may be combined with the other D2D feedback procedure during each D2D feedback procedure.

For example, the RX feedback of the A/N-to-eNB method may be combined with the D2D feedback procedure of the A/N-to-TD method. In this case, the TD may receive the RX feedback from the eNB so as to clearly recognize whether the eNB receives ACK/NACK forward transmitted from the TD. In addition, when RX fail-retx is received, signaling for D2D data retransmission may be reduced, and thus the method according to this example may be useful.

Another example, when the A/N-to-eNB method and the A/N-to-TD method are entirely combined and used, the eNB may dynamically or semi-statically indicate information about a used method of the A/N-to-eNB method and the A/N-to-TD method according to a situation. When the eNB dynamically indicates the information, the information may be indicated through, for example, a D2D trigger such as a PDCCH or a PDSCH. When the eNB semi-statically indicates the information, the information may be indicated via higher layer signaling, for example, RRC.

Information about resource and transmission time for transmission of TX feedback, RX feedback, and ACK/NACK forward as well as the ACK/NACK feedback may be pre-configured via higher layer signaling (e.g., RRC signaling) or indicated via a D2D trigger such as PDCCH/PDSCH, etc.

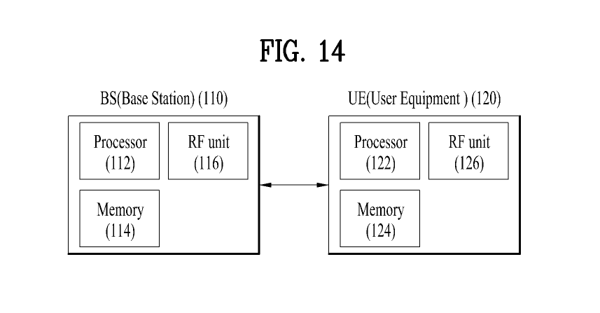

FIG. 14 is a diagram illustrating a BS 110 and a UE 120 to which the present invention is applicable.

Referring to FIG. 14, a wireless communication system includes the BS 110 and the UE 120. When the wireless communication system includes a relay, the BS 110 or the UE 120 can be replaced with the relay.

The BS 110 includes a processor 112, a memory 114, and a radio frequency (RF) unit 116. The processor 112 may be configured to embody the procedures and/or methods proposed by the present invention. The memory 114 is connected to the processor 112 and stores various pieces of information associated with an operation of the processor 112. The RF unit 116 is connected to the processor 112 and transmits/receives a radio signal. The UE 120 includes a process 122, a memory 124, and an RF unit 126. The processor 122 may be configured to embody the procedures and/or methods proposed by the present invention. The memory 124 is connected to the processor 122 and stores various pieces of information associated with an operation of the processor 122. The RF unit 126 is connected to the processor 122 and transmits/receives a radio signal.

The embodiments of the present invention described above are combinations of elements and features of the present invention. The elements or features may be considered selective unless otherwise mentioned. Each element or feature may be practiced without being combined with other elements or features. Further, an embodiment of the present invention may be constructed by combining parts of the elements and/or features. Operation orders described in embodiments of the present invention may be rearranged. Some constructions of any one embodiment may be included in another embodiment and may be replaced with corresponding constructions of another embodiment. It is obvious to those skilled in the art that claims that are not explicitly cited in each other in the appended claims may be presented in combination as an embodiment of the present invention or included as a new claim by a subsequent amendment after the application is filed.

Specific operations to be conducted by the base station in the present invention may also be conducted by an upper node of the base station as necessary. In other words, it will be obvious to those skilled in the art that various operations for enabling the base station to communicate with the terminal in a network composed of several network nodes including the base station will be conducted by the base station or other network nodes other than the base station. The term “base station (BS)” may be replaced with a fixed station, Node-B, eNode-B (eNB), or an access point as necessary. The term “terminal” may also be replaced with a user equipment (UE), a mobile station (MS) or a mobile subscriber station (MSS) as necessary.

The embodiments of the present invention may be achieved by various means, for example, hardware, firmware, software, or a combination thereof. In a hardware configuration, an embodiment of the present invention may be achieved by one or more application specific integrated circuits (ASICs), digital signal processors (DSPs), digital signal processing devices (DSDPs), programmable logic devices (PLDs), field programmable gate arrays (FPGAs), processors, controllers, microcontrollers, microprocessors, etc.

In a firmware or software configuration, an embodiment of the present invention may be implemented in the form of a module, a procedure, a function, etc. Software code may be stored in a memory unit and executed by a processor. The memory unit is located at the interior or exterior of the processor and may transmit and receive data to and from the processor via various known means.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

### INDUSTRIAL APPLICABILITY

The present invention is applicable to a wireless communication apparatus such as a user equipment (UE), a base station (BS), etc.

1. A method for transmitting and receiving a control signal by a first user equipment (UE) in a wireless communication system supporting a device-to-device (D2D) communication, the method comprising:
receiving a signal for triggering a D2D communication between the first UE and a second UE from a base station (BS);
transmitting data to the second UE;
receiving an acknowledgement (ACK)/negative ACK (NACK) signal for the data from the second UE; and
transmitting, to the BS, an ACK/NACK delivery signal for transmitting the ACK/NACK signal to the BS.

2. The method according to claim 1, wherein the ACK/NACK delivery signal indicates ACK when the ACK/NACK signal indicates ACK, and the ACK/NACK delivery signal indicates NACK when the ACK/NACK signal indicates NACK or discontinuous transmission (DTX).

3. The method according to claim 1, wherein the ACK/NACK delivery signal indicates ACK when the ACK/NACK signal indicates ACK, the ACK/NACK delivery signal indicates NACK when the ACK/NACK signal indicates NACK, and the ACK/NACK delivery signal indicates DTX when the ACK/NACK signal indicates DTX.

4. The method according to claim 1, wherein the ACK/NACK delivery signal is transmitted via physical uplink control channel (PUCCH) format 1a/1b.

5. The method according to claim 1, further comprising
transmitting, to the second UE, scheduling information for scheduling data transmission to the second UE,
wherein the scheduling information comprises resource allocation information, information about a modulation and coding scheme, and/or information about a transport block size, for data transmission to the second UE.

6. The method according to claim 1, further comprising:
receiving control information for the D2D communication between the first UE and the second UE from the BS,
wherein the control information for the D2D communication comprises information about a specific subframe in which data transmission to the second UE is permitted, and the data transmission to the second UE is performed in the specific subframe.

7. The method according to claim 1, wherein information about resource and time for transmitting the ACK/NACK delivery signal to the BS is received via higher layer signaling or received via the signal for triggering the D2D communication.

8. The method according to claim 1, wherein the second UE is outside a coverage of the BS.

9. A first user equipment (UE) for transmitting and receiving a control signal in a wireless communication system for supporting a device-to-device (D2D) communication, the first UE comprising:
a radio frequency (RF) unit; and
a processor,
wherein the processor is configured to receive a signal for triggering a D2D communication between the first UE and a second UE from a base station (BS) through the RF unit, to transmit data to the second UE, to receive an acknowledgement (ACK)/negative ACK (NACK) signal for the data from the second UE, and to transmit, to the BS, an ACK/NACK delivery signal for transmitting the ACK/NACK signal to the BS.

10. The UE according to claim 9, wherein the ACK/NACK delivery signal indicates ACK when the ACK/NACK signal indicates ACK, and the ACK/NACK delivery signal indicates NACK when the ACK/NACK signal indicates NACK or discontinuous transmission (DTX).

11. The UE according to claim 9, wherein the ACK/NACK delivery signal indicates ACK when the ACK/NACK signal indicates ACK, the ACK/NACK delivery signal indicates NACK when the ACK/NACK signal indicates NACK, and the ACK/NACK delivery signal indicates DTX when the ACK/NACK signal indicates DTX.

12. The UE according to claim 9, wherein the ACK/NACK delivery signal is transmitted via physical uplink control channel (PUCCH) format 1a/1b.

13. The UE according to claim 9, wherein the processor is further configured to transmit, to the second UE, scheduling information for scheduling data transmission to the second UE from the first UE, and
wherein the scheduling information comprises resource allocation information, information about a modulation and coding scheme, and/or information about a size of a transport block, for data transmission to the second UE from the first UE.

14. The UE according to claim 9, wherein the processor is further configured to receive control information for the D2D communication between the first UE and the second UE from the BS, and
wherein the control information for the D2D communication comprises information about a specific subframe in which data transmission to the second UE from the first UE is permitted, and the data transmission to the second UE from the first UE is performed in the specific subframe.

15. The UE according to claim 9, wherein information about resource and time for transmitting the ACK/NACK delivery signal to the BS is received via higher layer signaling or received via the signal for triggering the D2D communication.
